(19) United States
(12) Patent Application Publication
(10) Pub. No.: US 2023/0330709 A1
(43) Pub. Date: Oct. 19, 2023

(54) PLANT LEAF CLEANER

(71) Applicants: RAMON O'BRIEN HUTCHINSON, CASTLE PINES, CO (US); SABINA KATARZYNA MARSZAL, CASTLE PINES, CO (US)

(72) Inventors: RAMON O'BRIEN HUTCHINSON, CASTLE PINES, CO (US); SABINA KATARZYNA MARSZAL, CASTLE PINES, CO (US)

(21) Appl. No.: 17/721,825

(22) Filed: Apr. 15, 2022

(51) Int. Cl. B08B 1/00

(52) U.S. Cl. CPC B08B 1/006; B08B 2240/00

(57) ABSTRACT

A tool for cleaning, preserving, and applying solution to plant's leaves. The tool includes a pair of tongs accompanied by removable, washable, and durable material cleaning pads along each tong's arm. The pads cover the arms of the tongs while in use and are made of a quick-drying material allowing for the pads to be removed, washed/cleaned as desired, and reused multiple times, making the invention sustainable. The tongs are used to grasp a leaf of a plant and to clean it by running the tongs across the leaf's surface. The tool can be used on a wide variety of leafy plants, cleaning large leaves as well as those as small as 2.5 inches in size. The pad's material is delicate to plant's leaves, and a removable protective spacer placed on the lower inner arm of the tongs prevents the leaves from being damaged or squeezed too hard. The removable pads can be used dry as well as wet, using water or any other desired cleaning and shining solution.

### BACKGROUND OF THE INVENTION

The present invention relates to a plant cleaning tool specifically designed for use on leafy plants, indoors and outdoors, of a wide variety. The tool can be used cleaning dry leaves or in combination with a cleaning solution of choice.

Plants collect dust and dirt debris, but also gather residue leftover from various sprays used for plants preservation. This may affect plant's photosynthesis, respiration, transpiration, and therefore lead to visible plant injury symptoms or even plant's death. A layer of dust and debris on plant's leaves reduces the amount of sunlight the plant receives and by that, reduces the amount of oxygen emitted by the plant.

### DESCRIPTION OF THE PRIOR ART

There are a few previously issued patents related to dusting and cleaning devices. Most of them are intended for cleaning of Venetian or vertical blinds, and therefore not suitable to use with the purpose of cleaning delicate plants' leaves.

Several inventions in the prior are describe devices for use with Venetian blinds. Lex U.S. Pat. No. 4,277,861 is directed to a cleaning device designed to clean Venetian blinds. This device comprises a pair of cleaning bodies mounted on a hand-held housing and by allowing small vibrations, it can remove dust and debris from blinds. Similarly, Kuehnl U.S. Pat. No. 4,718,141 is directed to a device which, by incorporating multiple elongated protuberances, effects an orderly and thorough removal of dust and similar particles from the slats of Venetian blinds and other louvered structures.

Also, Brown et al. U.S. Pat. No. 6,883,988 B1 is directed to a vertical blind cleaning tool which includes an elongated handle ended with two prongs. An adsorptive membrane is coupled to the prong portion of the tool, and while fluid may flow to the membrane, the membrane can be moved along either side of a vertical blind.

Further, Collins U.S. Pat. No. 7,430,781 B2 is directed toward a window blind cleaning system for cleaning the slats of both vertical and horizontal blinds. It allows its user to select cleaning material which is then placed over the cleaning heads of the tool. The device comprises a handle, an extension handle, handle mounted trigger, and plates with attached cleaning pads forming the cleaning heads of the device. The cleaning pads are removably attached and both the plates and the pads are shaped to conform to the blind's slats.

The inventions mentioned above are directed primarily toward cleaning Venetian and vertical blinds and therefore not suitable nor designed for use with fragile and delicate plants' leaves. Further, they do not comprise of a pair of tongs.

Other invention are designed for cleaning of other objects. Home U.S. Pat. No. 5,369,836 is directed to cleaning of ceiling fan blades. It includes a flexible, flat tubular, textile elongated sleeve that completely encases a fan blade from tip to root, allowing for dirt removal. The Home's invention is useful for its intended use, however, like the earlier mentioned devices, it is not suitable nor designed for cleaning delicate plants. It does not comprise of tongs, nor of removable pads designed specifically to clean plants' leaves.

Anderson U.S. Pat. No. 9,201,252 B2 is directed to a tool designed to remove debris from a glass surface. It comprises a lower and upper arm and pads on each of the mentioned arms. The arms of the device are rotationally coupled together. Since this tool's size is designed to clean smaller glass surfaces, it is not suitable to clean bigger objects, like plants' leaves. Moreover, the device's arms do not operate like tongs and therefore, even if of larger size, it would not allow for open/close movement required to clean the plant's leaves sufficiently.

Currently, there exists a need in the art for a tool which allows efficient and easy cleaning of plants' leaves. The present invention not only accomplishes this purpose but can be also used to apply various solutions to plants' leaves and the removable and reusable cleaning pads are easy to clean in between uses. Its design and intent significantly diverge in design elements from the above referenced inventions of art.

### SUMMARY OF THE INVENTION

In view of the lack of existing plant cleaners, the present invention provides a new cleaning tool which can be utilized for cleaning dust and other debris from plants' leaves. It can be also used to apply various solutions to plants' leaves while providing convenience of cleaning the removable and reusable pads after the use if desired.

The current invention is designed to efficiently remove dust, dirt, and any other debris from the leaves of plants. The tool includes a pair of tongs accompanied by removable, washable, and durable material cleaning pads along each tong's arm. The pads cover the arms of the tongs while in use and are made of a quick-drying material allowing for the pads to be removed, washed/cleaned as desired, and reused multiple times, making the invention sustainable.

The tongs are used to grasp a leaf of a plant and to clean it by running the tongs across the leaf's surface. The tool can be used on a wide variety of leafy plants, cleaning large leaves as well as those as small as 2.5 inches in size. The pad's material is delicate to plant's leaves, and a removable protective spacer placed on the lower inner arm of the tong prevents the leaves from being damaged or squeezed too hard. The removable cleaning pads can be used dry as well as wet, using water or any other desired cleaning and shining solution.

When the tool is rubbed on the plants' leaves it will simultaneously clean the top and bottom surface of each leaf. It can also serve to apply a solution of user's choice at the same time. Such solution can be applied directly on the pads of the tool, and then rubbed on the leaves of a plant, without the risk of over-spraying the solution, or applying it mistakenly to nearby walls or other areas around the plant which the solution can moisten or stain in any way.

Because the current invention is designed to clean dirt, dust, or other debris from the plants' leaves, but can be also used to apply a desired solution to the plants' leaves, it is utmost important for the cleaning pads to be removable, washable, and reusable to support sustainability. The material from which the cleaning pads are made is also quick drying allowing for the pads to be cleaned and reused frequently.

Other elements, features, and benefits of the current invention will become apparent from the following detailed description accompanied by drawings.

### BRIEF DESCRIPTION OF THE DRAWINGS

The present invention may be better understood by referring to the following description made in connection with the accompanied drawings.

FIG. 1 is a perspective view of the present invention in use.

FIG. 2 shows a perspective view of the present invention, alongside the removable cleaning pads, and the removable protective spacer.

FIG. 3 is a perspective view of the present invention demonstrating the removable cleaning pads and the way they can be open and closed in order to be removed from the tool.

FIG. 4 is a perspective view of the current invention specifically demonstrating the purpose of the removable protective spacer and the role it plays in protecting the plants' leaf from being hurt in the process of cleaning.

### DETAILED DESCRIPTION OF THE INVENTION

Referring in more details to FIG. 2, it shows a perspective view of the present invention. The device is composed of a set of ergonomically designed tongs 47. Each arm of the tongs 47 is equipped with a removable and reusable cleaning pads 46. The lower arm of the tongs 47 is equipped with a removable protective spacer 49 which prevents the delicate plants' leaves from being squeezed too tight and potentially harmed during cleaning. The shape of the present invention as demonstrated on FIG. 2 allows for cleaning all types of plants' leaves, from round to elongated ones. The size of the device allows for efficient cleaning of large leaves but also those as small as 2.5 inches in size.

Referring now to FIG. 3, there is shown a perspective view of the current invention focusing on the cleaning pads 46. The drawing represents the hook and loop fasteners 50 on the cleaning pads 46 demonstrating in more details how the cleaning pads 46 can be open and closed allowing for them to be put on and removed from the tongs 47. The pads are soft and allow for gentle cleaning of fragile plants' leaves. FIG. 3 shows also the ergonomic design 51 of the tongs 47 allowing for easier and more comfortable grasp of the tool during use. The ergonomic design 51 of the tongs 47 allow for comfortable placement of four fingers while the thumb is intended to be placed on the opposite arm of the tongs 47.

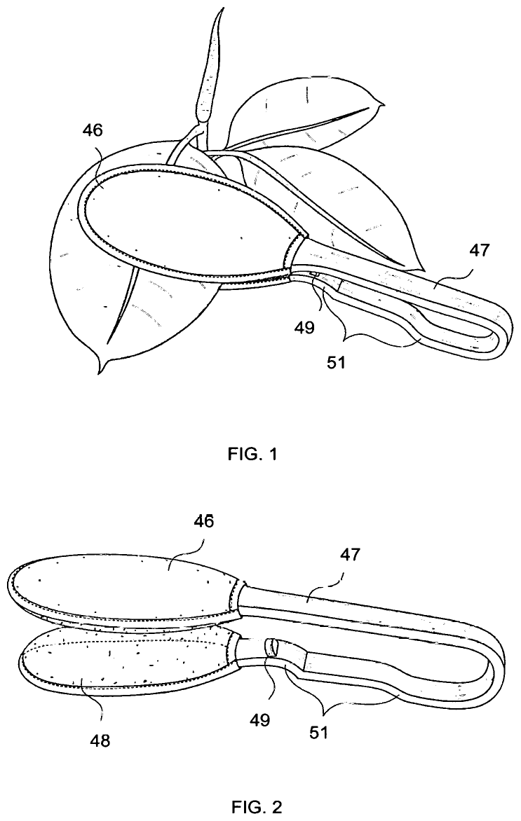

Referring now to FIG. 1 there is shown a perspective view of the current invention while in use. The cleaning pads 46 are meant to hug the plants' leaf during cleaning and are design for easy and efficient use. The removable, protective spacer 49 prevents the leaf to be harmed by crushing or squeezing too tightly by the tongs while cleaning allowing for the user's peace of mind. The user of the device can clean the plants' leaves by moving the tool alongside the leave from its base to the top, or by moving the tool sideways—depending on shape and size of the leaf. As the tongs 47 and cleaning pads 46 slide on the leaf, the bottom and top part of the leaf are being cleaned simultaneously. The device can clean plants' leaves when dry, or when moist by ether water or a desired solution of choice. The device can be also used to shine the leaves of the plant. Irrespectively of whether the tool is used on dry or moist leaves, the removable and reusable cleaning pads 46 are easy to wash and put back on the device. Being made of quick-drying and durable and long-lasting material the cleaning pads 46 are designed for frequent cleaning and washing as needed.

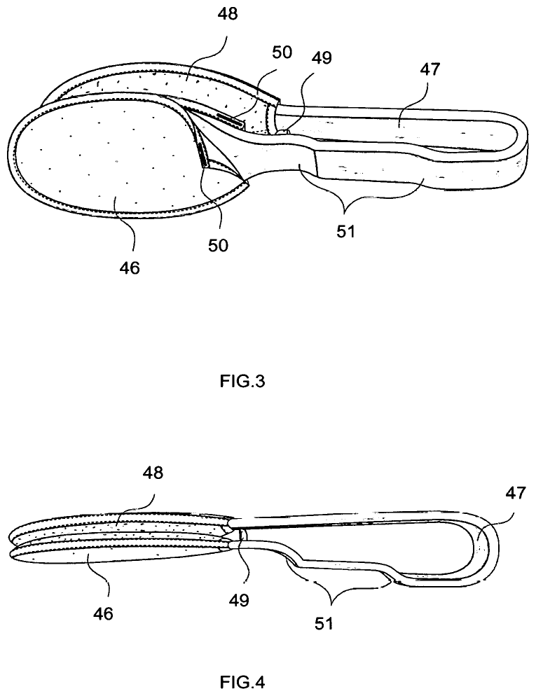

Referring to FIG. 4 there is shown a perspective view of the current invention in use specifically focusing on the purpose of the removable, protective spacer 49 and the role it plays protecting the plant's leaf from being damaged while being cleaned. With the protective spacer 49 in place, pressure can be applied to the tool when cleaning the plant's leaf while maintaining user's peace of mind and preventing worry about harming the plant in the process.

With respect to the above description, it is to be understood that the optimum dimensional relationship for the parts of the invention, to include variation in size, materials, shape, form, function, and manner of use are apparent to one skilled in the art, and all equivalent relationships to those illustrated in the drawings and described in the specification are intended to be defined by the present invention.

With that said, since various modifications and improvements will occur to the invention, it is not desired to limit the invention to the exact construction and operation shown and described, and accordingly, all suitable modifications and equivalents may be resorted to, falling within the scope if the invention.

I claim:

1. A hand operated device for cleaning dirt, dust, and other debris from or applying a desired solution of choice to a plant leaf, comprising:
an ergonomically designed tong consisting of two arms connected at the base and providing an open end for clasping plants' leaves between said tong's arms ends;
removable cleaning pads intended to be put on the tong's arms ends when the tool is in use;
removable, protective spacer which can be attached to the bottom arm of the tong, and which protects the leaf from being clasp too tightly during cleaning;

2. A method of cleaning a leaf or applying a desired solution of choice to the leaf, comprising:
dressing each arm of the tong with a removable cleaning pads;
clasping a plant's leaf in between the tong's arm ends;
cleaning dirt, dust or other debris from plant's leaf or applying a desired solution of choice to plant's leaf by gently sliding the clasp ends of the tool's arm either along the leaf or side to side, depending on leaf's shape and size.
